(19) United States
(12) Patent Application Publication
(10) Pub. No.: US 2025/0245290 A1
(43) Pub. Date: Jul. 31, 2025

(54) ARITHMETIC DEVICE

(71) Applicants: Preferred Networks, Inc., Tokyo (JP); NATIONAL UNIVERSITY CORPORATION KOBE UNIVERSITY, Hyogo (JP)

(72) Inventors: Junichiro MAKINO, Hyogo (JP); Tomoya ADACHI, Tokyo (JP); Gentaro WATANABE, Tokyo (JP); Ken NAMURA, Tokyo (JP)

(21) Appl. No.: 19/041,301

(22) Filed: Jan. 30, 2025

(30) Foreign Application Priority Data
Jan. 31, 2024 (JP) 2024-012553

(51) Int. Cl. G06F 17/16; G06F 7/487

(52) U.S. Cl. CPC G06F 17/16; G06F 7/4876

(57) ABSTRACT

An arithmetic device includes a plurality of multiply-add circuits, each of which includes a plurality of multipliers and a first adder, each of the plurality of multipliers being configured to multiply a data pair of significands of floating-point number data, and the first adder being configured to add results of the multiplication by the plurality of multipliers and a correction value; and an addition circuit configured to add operation results output from the plurality of multiply-add circuits and output a result of the addition as a matrix multiplication result of significand data of any of a plurality of types of floating-point number formats.

### CROSS-REFERENCE TO RELATED APPLICATIONS

This patent application is based on and claims priority to Japanese Patent Application No. 2024-012553 filed on Jan. 31, 2024, the entire contents of which are incorporated herein by reference.

### TECHNICAL FIELD

The present disclosure relates to an arithmetic device.

### BACKGROUND

An arithmetic device used in an application that performs processing such as deep learning is required to have high arithmetic performance in order to perform a large number of matrix operations. Therefore, an application specific integrated circuit (ASIC) on which a large number of matrix operation circuits are mounted may be used as an arithmetic device in order to improve the arithmetic performance of the arithmetic device.

There is an upper limit to the number and size of the matrix operation circuits that can be implemented in an ASIC, such as a processor chip. For example, when matrix operations using floating-point number data of multiple levels of precision are required in applications, it is preferable to mount a matrix operation circuit for each precision on a processor chip. However, due to the restriction of the circuit scale, it may be difficult to mount multiple matrix operation circuits for required accuracy on a processor chip. Additionally, the power consumption may increase as the circuit scale increases.

Here, as an example of the floating-point number data, a block floating-point number format is known in which the exponents of multiple floating-point number data are shared by multiple data. In the block floating-point number format, for example, the exponent of multiple floating-point number data in a matrix may be shared by using the exponent of the largest floating-point number data in the matrix.

### SUMMARY

An arithmetic device according to one aspect of the present disclosure includes a plurality of multiply-add circuits, each of which includes a plurality of multipliers and a first adder, each of the plurality of multipliers being configured to multiply a data pair of significands of floating-point number data, and the first adder being configured to add results of the multiplication by the plurality of multipliers and a correction value; and an addition circuit configured to add operation results output from the plurality of multiply-add circuits and output a result of the addition as a matrix multiplication result of significand data of any of a plurality of types of floating-point number formats.

### BRIEF DESCRIPTION OF THE DRAWINGS

FIG. 1 is a block diagram illustrating an example of a configuration of an arithmetic device according to a first embodiment of the present disclosure;

FIG. 2 is a circuit block diagram illustrating an example of a multiplication execution circuit of FIG. 1;

FIG. 3 is a diagram illustrating an example of a half precision, pseudo single precision, single precision, and double precision floating-point number format;

FIG. 4 is a diagram illustrating an example of matrix multiplication of significands of half-precision data performed by the multiplication execution circuit in FIG. 2;

FIG. 5 is a diagram illustrating an example of matrix multiplication of significands of pseudo single precision data performed by the multiplication execution circuit in FIG. 2;

FIG. 6 is a diagram illustrating an example of matrix multiplication of significands of single precision data performed by the multiplication execution circuit in FIG. 2;

FIG. 7 is a diagram illustrating an example of replacement with a correction value when matrix multiplication of single precision data is performed;

FIG. 8 is a diagram illustrating an example of matrix multiplication of significands of double precision data performed by the multiplication execution circuit in FIG. 2;

FIG. 9 is a diagram illustrating an example of a flow of operations when the multiplication execution circuit in FIG. 2 performs the matrix multiplication of the significands of the double precision data;

FIG. 10 is a diagram illustrating an example of replacement with a correction value when the matrix multiplication of the double precision data is performed;

FIG. 11 is a block diagram illustrating an example of a configuration of an arithmetic device according to a second embodiment of the present disclosure;

FIG. 12 is a diagram illustrating an example of matrix multiplication of the significands of the pseudo single precision data performed by the multiplication execution circuit in FIG. 11;

FIG. 13 is a diagram illustrating an example of matrix multiplication of the significands of the single precision data performed by the multiplication execution circuit in FIG. 11;

FIG. 14 is a diagram illustrating an example of matrix multiplication of the significands of the double precision data performed by the multiplication execution circuit in FIG. 11;

FIG. 15 is a diagram illustrating an example of matrix multiplication of the significands of the double precision data performed by the multiplication execution circuit in FIG. 11; and

FIG. 16 is a block diagram illustrating an example of a hardware configuration of a computer on which the arithmetic device illustrated in FIG. 1 is mounted.

### DETAILED DESCRIPTION OF EMBODIMENTS

In the present disclosure, matrix operations using floating-point number data of multiple levels of precision can be performed while suppressing an increase in circuit scale.

In the following, embodiments of the present disclosure will be described in detail with reference to the drawings. Although not particularly limited, an arithmetic device may be a processor mounted on a computer, such as a server, and may execute a program (instruction) to perform a convolution operation or the like in training or inference of a deep neural network. Here, the arithmetic device described below may be used for scientific and technical calculation or the like.

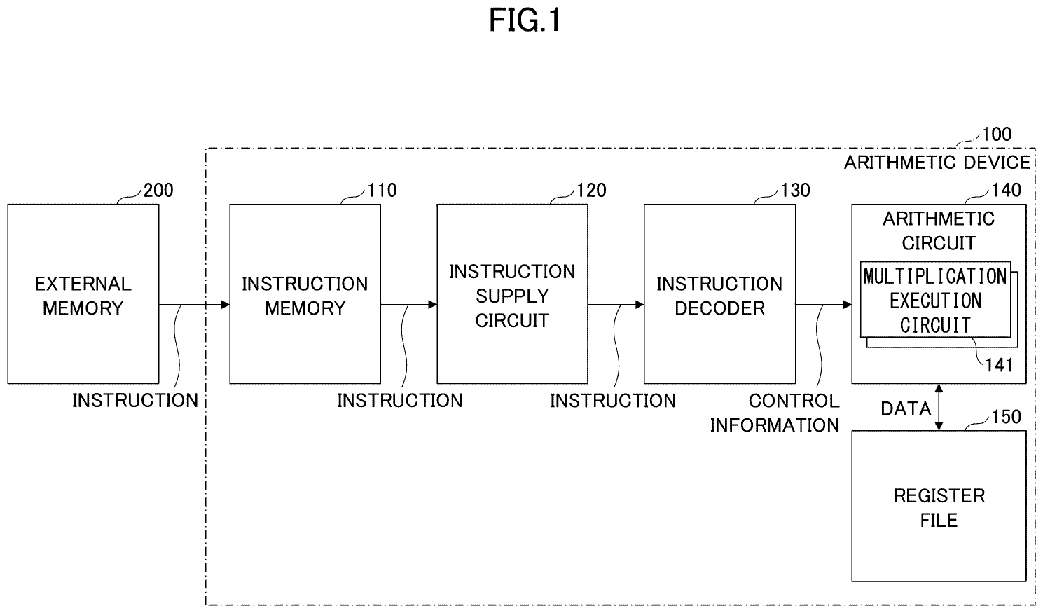

FIG. 1 is a block diagram illustrating an example of a configuration of an arithmetic device according to a first embodiment of the present disclosure. For example, an arithmetic device 100 illustrated in FIG. 1 may be formed by hardware (a circuit). The arithmetic device 100 may include an instruction memory 110, an instruction supply circuit 120, an instruction decoder 130, an arithmetic circuit 140, and a register file 150. The arithmetic device 100 may be a processor in the form of a chip.

The instruction memory 110 may hold an instruction transferred from an external memory 200 and sequentially output the held instruction to the instruction supply circuit 120. The instruction supply circuit 120 may sequentially supply the instruction transferred from the instruction memory 110 to the instruction decoder 130. The instruction decoder 130 may decode the instruction received from the instruction supply circuit 120 to generate control information necessary for execution of the instruction, and output the generated control information to the arithmetic circuit 140. The instruction decoder 130 is an example of an instruction output circuit configured to output, to the multiplication execution circuit 141, control information for identifying a type of matrix multiplication to be performed and a floating-point number format together with a data pair of significands of floating-point number data.

The arithmetic circuit 140 may include multiple multiplication execution circuits 141 configured to perform multiplication of the significands of the floating-point number data or block floating-point number data. Additionally, the arithmetic circuit 140 may include another multiplication execution circuit configured to perform multiplication of data in a format other than the floating-point number format or the block floating-point number format. Furthermore, the arithmetic circuit 140 may include one or more arithmetic execution circuits configured to perform arithmetic operations other than multiplication. In the following, the description of the multiplication of the significands of the floating-point number data performed by the multiplication execution circuit 141 can be appropriately applied to the multiplication of the significands of the block floating-point number data. Additionally, the description of the multiplication of the significands of the block floating-point number data can be appropriately applied to the multiplication of the significands of the floating-point number data. Here, the multiplication execution circuit 141 may include an arithmetic circuit configured to calculate the exponent part and the sign part of the floating-point number data or the block floating-point number data.

The register file 150 may hold data on which an operation is to be performed by the arithmetic circuit 140 and data of a result of the operation performed by the arithmetic circuit 140. Here, the arithmetic device 100 may include an internal memory, which is not illustrated, connected to the register file 150. The internal memory may be configured such that data can be transferred to and from the register file 150 and data can be directly or indirectly transferred to and from the external memory 200. Here, the circuit configuration of the arithmetic device 100 illustrated in FIG. 1 is an example, and the arithmetic device 100 only needs to include at least the multiplication execution circuit 141.

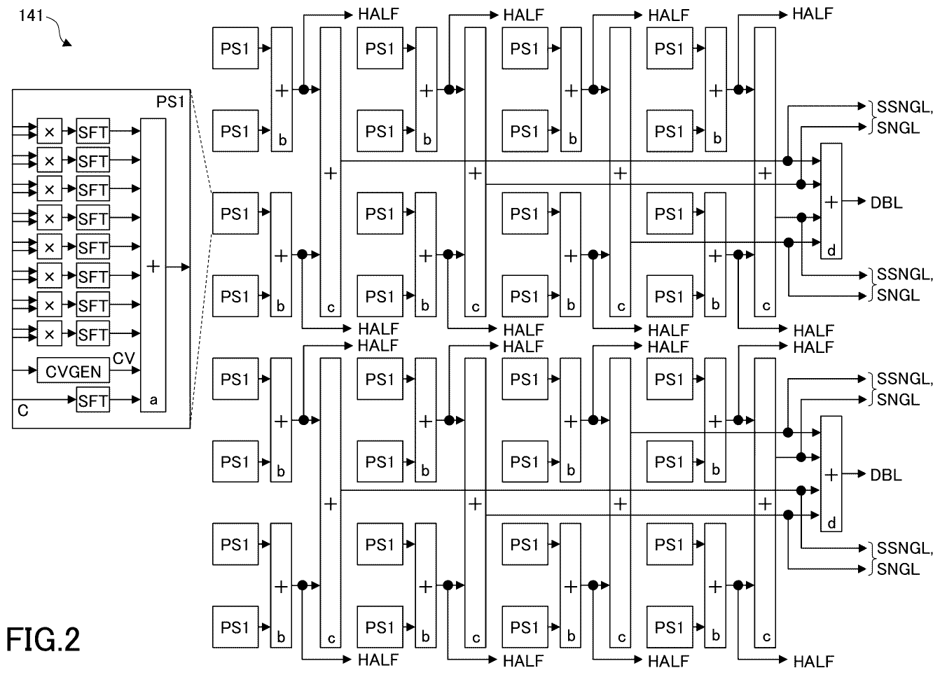

FIG. 2 is a circuit block diagram illustrating an example of the multiplication execution circuit 141 of FIG. 1. The multiplication execution circuit 141 may include multiple multiply-add circuits PS1 and multiple adders b, c, and d connected to outputs of the multiply-add circuits PS1. Although not particularly limited, the multiplication execution circuit 141 may include 32 multiply-add circuits PS1, 16 adders b, 8 adders c, and 2 adders d. The adders b, c, and d are examples of a third adder, a fourth adder, and a fifth adder, respectively. The adders b, c, and d are an example of an addition circuit.

Each of the multiply-add circuits PS1 may include eight multipliers indicated by rectangles with a symbol x, shifters SFT respectively connected to outputs of the multipliers, a correction value generation circuit CVGEN configured to generate a correction value CV, an adder a, and a shifter SFT arranged in a path for supplying a carry C to the adder a. The adder a may add output values from the shifters SFT respectively connected to the multipliers, the correction value CV from the correction value generation circuit CVGEN, and the carry C bit-shifted by the shifter SFT. The adder a is an example of a first adder. Here, the number of multipliers mounted in each of multiply-add circuits PS1 may be 2 to the power of i (i is a positive integer of 2 or greater), but the present disclosure is not limited thereto.

The multipliers may multiply a 9-bit data pair indicating the significands of the floating-point number data or a 9-bit partial significand data pair obtained by dividing each of the data pair of the significands, and output multiplication results to the shifters SFT.

The correction value generation circuit CVGEN may determine whether to generate the correction value CV, based on information indicating the precision (the half precision, the single precision, or the like) of the floating-point number data included in the control information supplied from the instruction decoder 130, for example. When the single-precision or double-precision floating-point number data is supplied, the correction value generation circuit CVGEN may generate the correction value CV based on the partial significand data pair that is not assigned to the multiplier, and may output a fixed correction value CV, such as “0”, when one of the partial significand data pair is zero, for example. Alternatively, an average value of the maximum value and the minimum value that the partial significand data pair can take may be output as the fixed correction value CV. The correction value generation circuit CVGEN configured to output the fixed correction value CV may be a data hold circuit, such as a register. The correction value generation circuit CVGEN generates the correction value CV based on the partial significand data pair that is not assigned to the multiplier, and thus, even when the multiplication of the partial significand data pair is not performed, the deterioration of the accuracy of the matrix multiplication result can be suppressed.

When the single-precision or double-precision floating-point number data is not supplied, that is, when the half-precision or pseudo-single-precision floating-point number data is supplied, the correction value generation circuit CVGEN may output “0” without generating the correction value CV. With this, even when one multiplication execution circuit 141 is used for matrix multiplication of significands of floating-point number data of multiple levels of precision, the correction value CV can be generated at the time of matrix multiplication requiring the correction value CV, and generation of the correction value CV can be suppressed at the time of matrix multiplication not requiring the correction value CV. As a result, a malfunction of the arithmetic device 100 due to the correction value CV being erroneously generated can be suppressed.

For example, the outputs of the two multiply-add circuits PS1 may be connected to the inputs of the adder b, and the outputs of the two adders b may be connected to the inputs of the adder c. The outputs of the four adders c may be connected to the inputs of the adder d.

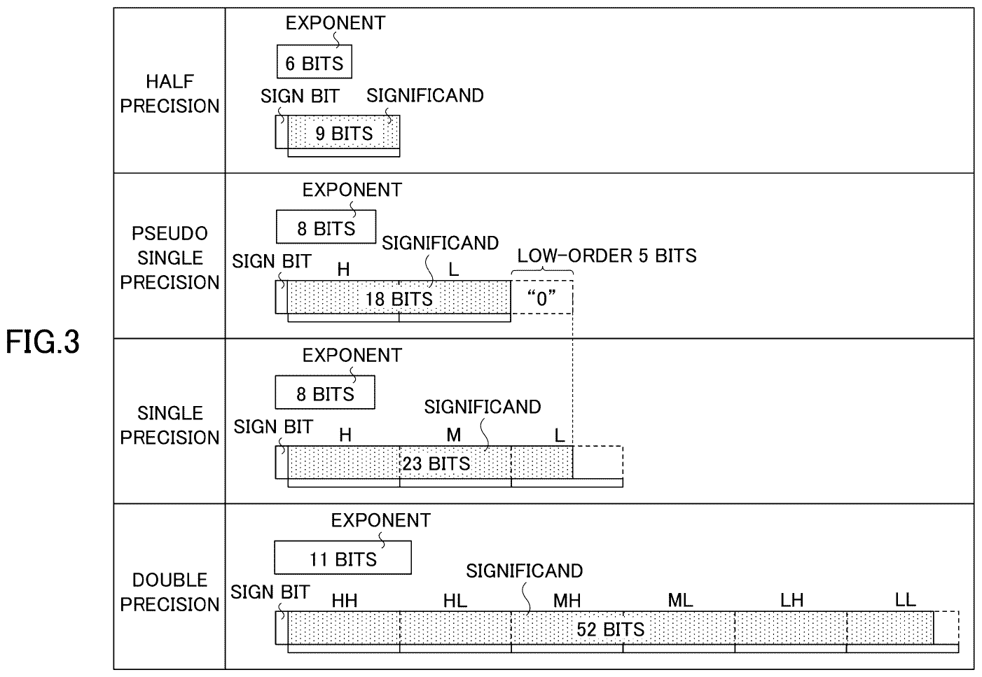

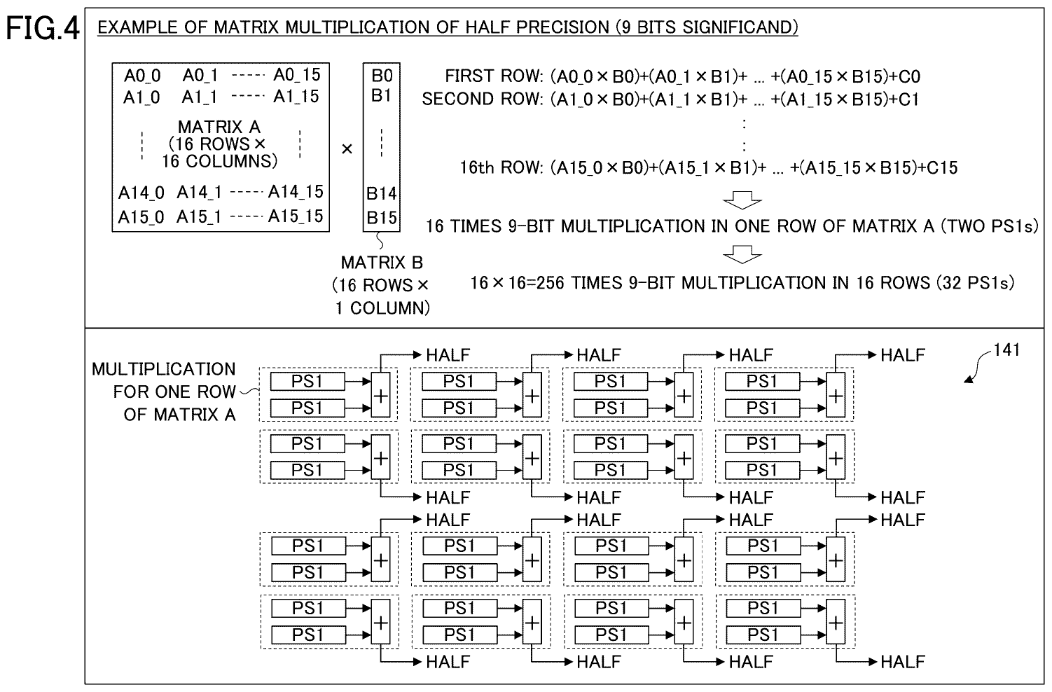

As will be described with reference to FIGS. 4 to 9, each of the adders b can output a matrix multiplication result HALF of the significands of the half-precision floating-point number data. Each of the adders c can output a matrix multiplication result SSNGL of the significands of the pseudo single-precision floating-point number or a matrix multiplication result SNGL of the significands of the single-precision floating-point number. The pseudo single precision will be described with reference to FIG. 3. Each of the adders d can output a multiplication result DBL of the significands of the double-precision floating-point number data. That is, the arithmetic device 100 can perform matrix multiplication of significands of floating-point number data of multiple levels of precision by the multiplication execution circuit 141.

FIG. 3 is a diagram illustrating an example of a half-precision, pseudo-single-precision, single-precision, and double-precision floating-point number format. The half-precision floating-point number data includes a sign bit of 1 bit, a significand of 9 bits, and an exponent of 6 bits, which is an exponent common to multiple half-precision data. The pseudo single-precision floating-point number data includes a sign bit of 1 bit, a significand of 23 bits (substantially 18 bits) in which the low-order 5 bits are set to “0”, and an exponent of 8 bits, which is an exponent common to multiple pseudo single precision data. The symbols H and L illustrated at the significand part of the pseudo single precision data indicate the high-order (most significant) 9 bits and the low-order (least significant) 9 bits of the significand.

The single-precision floating-point number data includes a sign bit of 1 bit, a significand of 23 bits, and an exponent of 8 bits, which is an exponent common to multiple single-precision data. The symbols H, M, and L illustrated at the significand part of the single-precision data indicate the high-order 9 bits, the middle-order 9 bits, and the low-order 5 bits of the significand.

The double-precision floating-point number data includes a sign bit of 1 bit, a significand of 52 bits, and an exponent of 11 bits, which is an exponent common to multiple double-precision data. The symbols HH, HL, MH, ML, LH, and LL illustrated at the significand part of the double-precision data each indicate 9 bits (LL indicates 7 bits) from the most significant bit of the significand.

In the following description, the data of the significand of the half-precision, pseudo-single-precision, single-precision, and double-precision floating-point data may be simply referred to as half-precision data, pseudo single-precision data, single-precision data, and double-precision data, respectively.

FIG. 4 is a diagram illustrating an example of matrix multiplication of significands of half-precision data performed by the multiplication execution circuit 141 of FIG. 2. In FIG. 4, matrix multiplication of significands of half-precision data for 16 rows of a matrix A of 16 rows×16 columns and a matrix B of 16 rows×1 column may be performed. Data of the significands of the elements of the matrix A and the matrix B are examples of data pairs. For example, the matrix A may be target data of the convolution operation, and the matrix B may be weights used for the convolution operation.

The multiplication result HALF of the matrix multiplication of the significands of each row of the matrix A can be obtained by performing multiplication of the significands of 9 bits 16 times using two multiply-add circuits PS1. Therefore, the multiplication execution circuit 141 of FIG. 2 can obtain 16 multiplication results HALF, which are matrix multiplication for 16 rows of the matrix A of 16 rows×16 columns and the matrix B of 16 rows×1 column.

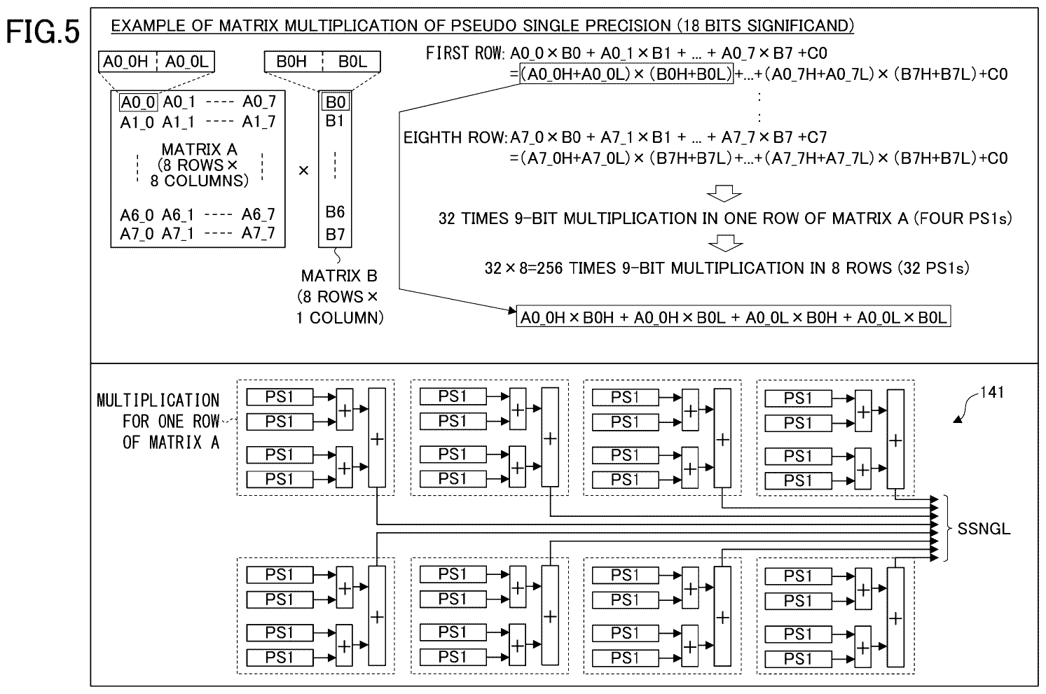

FIG. 5 is a diagram illustrating an example of matrix multiplication of significands of pseudo single-precision data performed by the multiplication execution circuit 141 of FIG. 2. In FIG. 5, matrix multiplication of significands of pseudo single-precision data for eight rows of a matrix A of eight rows×eight columns and a matrix B of eight rows×one column may be performed. In the description of the bit groups H and L in FIG. 5, the description of the row number and the column number is omitted.

In the pseudo single-precision matrix, as illustrated in FIG. 3, the significand of each of the elements of the matrix A and the matrix B may be divided into two groups, i.e., a bit group H of the high-order 9 bits and a bit group of the low-order 9 bits, in accordance with the bit width of the multipliers of the multiply-add circuit PS1. Therefore, in the significand of the pseudo single-precision data, the multiplication result of the matrix multiplication of one element can be obtained by performing the multiplication of 9 bits four times.

In each of the elements of the matrix A and the matrix B, the bit groups H and L of the significand are examples of the partial significand data. A combination of the bit group H or the bit group L of the matrix A and the bit group H or the bit group L of the matrix B is an example of the partial significand data pair. Here, the four multiplication results of the partial significand pairs may be added by the adder a after digit alignment using the shifters SFT in the multiply-add circuit PS1.

The multiplication result SSNGL of the matrix multiplication for one row (=8 elements) of the significand of the pseudo single precision can be obtained by performing multiplication of 9 bits 32 times using the four multiply-add circuits PS1. Therefore, by using the multiplication execution circuit 141 of FIG. 2, eight multiplication results SSNGL, which are results of matrix multiplication for eight rows of the matrix A with eight rows×eight columns and the matrix B of eight rows×one column, can be obtained.

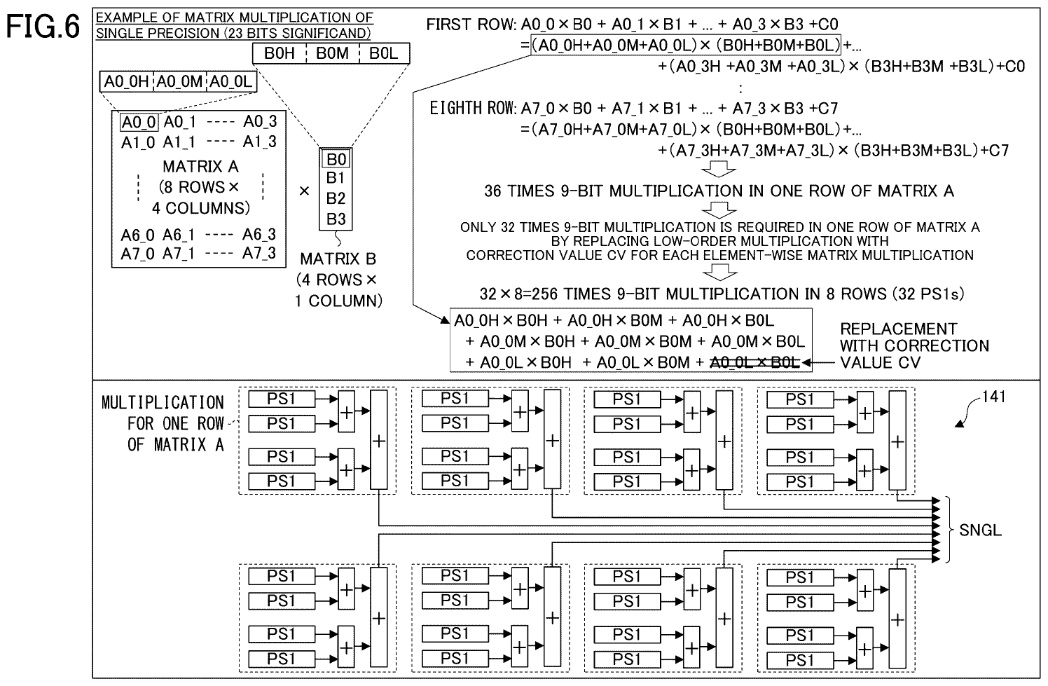

FIG. 6 is a diagram illustrating an example of matrix multiplication of significands of single-precision data performed by the multiplication execution circuit 141 of FIG. 2. In FIG. 6, matrix multiplication of significands of single-precision data for eight rows of a matrix A of eight rows×four columns and a matrix B of four rows×one column may be performed. In the description of the bit groups H, M, and L in FIG. 6, the description of the row number and the column number is omitted.

In the single-precision data, as illustrated in FIG. 3, the significand of each of the elements of the matrix A and the matrix B may be divided into three groups, i.e., a bit group H of the high-order 9 bits, a bit group M of the middle-order 9 bits, and a bit group L of the low-order 9 bits (in actuality, the low-order 5 bits), in accordance with the bit width of the multiply-add circuits PS1.

The bit groups A_H, A_M, and A_L in each of the elements of the matrix A and the bit groups BH, BM, and BL in each of the elements of the matrix B are examples of the partial significand data. A combination of any one of the bit group A_H, the bit group A_M, or the bit group A_L of the matrix A and any one of the bit group BH, the bit group BM, or the bit group BL of the matrix B are an example of the partial significand data pair.

The significand of each of the elements is divided into three, and thus the multiplication result of the matrix multiplication of one element can be obtained by performing multiplication of 9 bits nine times in the significand of the single-precision data. Therefore, a multiplication result SNGL of matrix multiplication of one row (four elements) of the single-precision data can be obtained by performing the multiplication of 9 bits 36 times. However, in this case, 288 9-bit multipliers are required to obtain eight multiplication results SNGL of the matrix multiplication for eight rows, and the multiplication execution circuit 141 of FIG. 2 including 256 9-bit multipliers cannot perform the multiplication.

In order to obtain eight multiplication results SNGL of the matrix multiplication for eight rows by the multiplication execution circuit 141, among the nine multiplications of the respective elements, the correction value CV may be used instead of the multiplication of the bit groups A_L and BL, and the multiplication of the respective elements may be performed eight times. That is, each of the multiply-add circuits PS1 may perform multiplication of a data pair of bit groups of a combination of the high-order bits among the bit groups of the matrix A and the matrix B by using multiple multipliers, and use the correction values CV instead of a data pair of bit groups that is not assigned to the multiplier. With this, the matrix multiplication for one row of the matrix A can be performed by the four multiply-add circuits PS1.

Therefore, by using the multiplication execution circuit 141 of FIG. 2, eight multiplication results SNGL, which are the results of the matrix multiplication for eight rows of the matrix A of eight rows×four columns and the matrix B of four rows×one column of the single-precision data, can be obtained. Here, the eight multiplication results of the partial significand data pairs of the respective elements may be added by the adder a after digit alignment using the shifters SFT in the multiply-add circuits PS1.

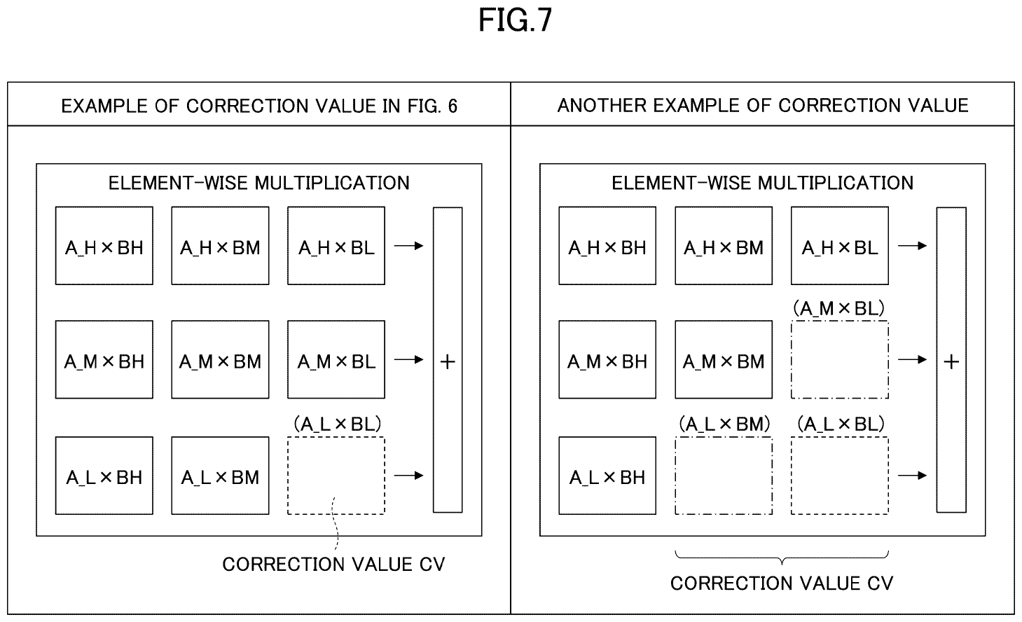

FIG. 7 is a diagram illustrating an example of replacement with the correction value when the matrix multiplication of the single-precision data is performed. In the matrix multiplication of the single-precision data illustrated in FIG. 6, as illustrated by a dashed line frame in the left frame of FIG. 7, the correction value CV may be given instead of performing the multiplication of the bit group A_L of the matrix A by the bit group BL of the matrix B for each of the elements. In this case, the correction value CV may be generated based on the bit groups A_L and BL, or may be set to a fixed value (for example, “0”).

Additionally, as another example of the correction value, if the accuracy of the matrix multiplication can be satisfied, as illustrated by a dashed-dotted line frame in the right frame of FIG. 7, the operation of the multiplier that multiplies the bit group A_M of the matrix A by the bit group BL of the matrix B for each of the elements and the operation of the multiplier that multiplies the bit group A_L of the matrix A by the middle bit group BM of the matrix B for each of the elements may be stopped. Then, the correction value CV may be given instead of performing the multiplication of the bit groups A_M and BL, the multiplication of the bit groups A_L and BM, and the multiplication of the bit groups A_L and BL. The correction value CV may be generated based on one or more of the pair of the bit groups A_M and BL, the pair of the bit groups A_L and BM, and the pair of the bit groups A_L and BL, or may be set to a fixed value (for example, “0”).

In this case, the number of the multipliers to be operated can be reduced in comparison with the example illustrated in FIG. 6, and thus the power consumption of the multiplication execution circuit 141 and the arithmetic device 100 can be reduced. The number of multipliers whose operations are to be stopped may be seven or less. For example, information (the position or the number) of the multiplier whose operation is to be stopped by the multiply-add circuit PS1 may be included in the control information supplied from the instruction decoder 130 (FIG. 1). Here, even when the matrix multiplication of the significands of the half-precision or pseudo single-precision floating-point number data illustrated in FIGS. 4 and 5 is performed, the operation of some of the multipliers may be stopped.

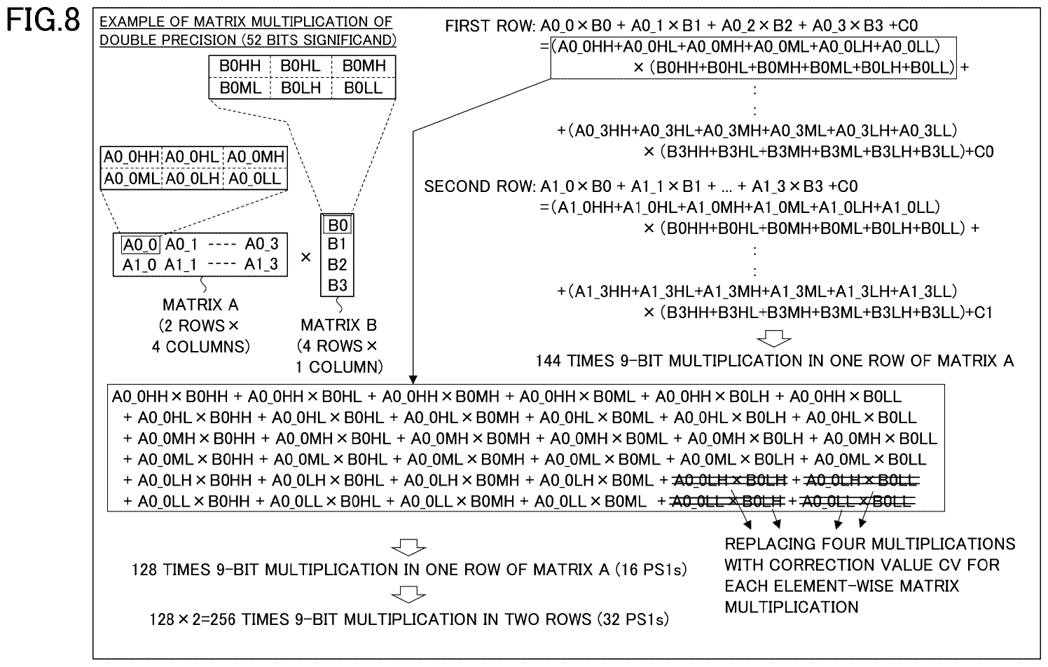

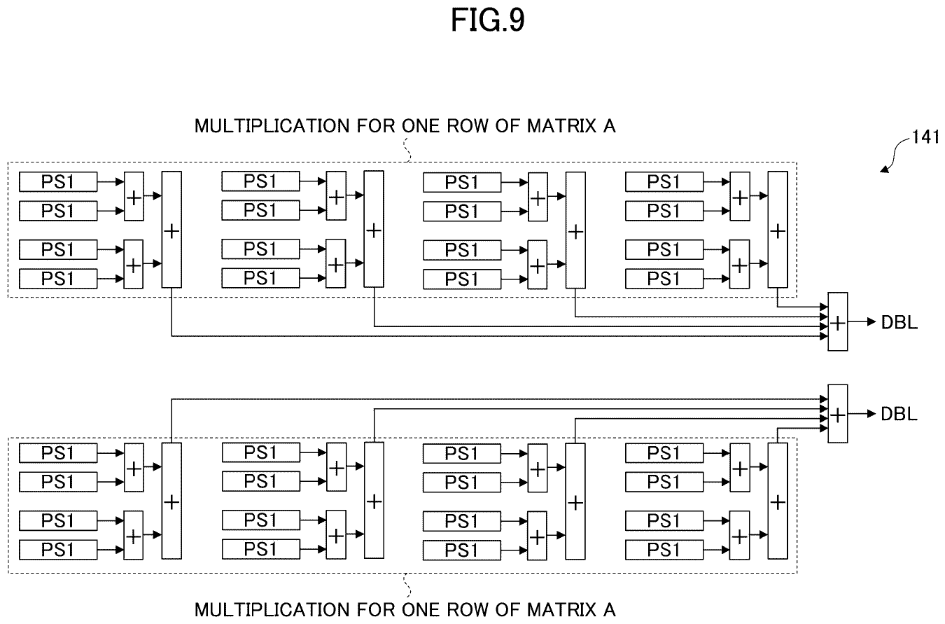

FIG. 8 is a diagram illustrating an example of matrix multiplication of significands of double-precision data performed by the multiplication execution circuit 141 of FIG. 2, and FIG. 9 is a diagram illustrating an example of a flow of arithmetic operations when the multiplication execution circuit 141 of FIG. 2 performs the matrix multiplication of the significands of the double-precision data. In FIGS. 8 and 9, matrix multiplication of significands of double-precision data for two rows of a matrix A of 2 rows×4 columns and a matrix B of 4 rows×1 column may be performed. In the description of the bit groups HH, HL, MH, ML, LH, and LL in FIG. 8, the description of the row number and the column number is omitted.

In the double precision, as illustrated in FIG. 3, the significand of each of the elements of the matrix A and the matrix B may be divided into six different 9-bit groups HH, HL, MH, ML, LH, and LL (in actuality, the bit group LL is 7 bits) in the order from the most significant bit in accordance with the bit width of the multiply-add circuits PS1.

In the elements of the matrix A and the matrix B, the bit groups A_HH, A_HL, A_MH, A_ML, A_LH, and A_LL and the bit groups BHH, BHL, BMH, BML, BLH, and BLL are examples of the partial significand data. A combination of any one of the bit group A_HH, the bit group A_HL, the bit group A_MH, the bit group A_ML, the bit group A_LH, or the bit group A_LL of the matrix A and any one of the bit group BHH, the bit group BHL, the bit group BMH, the bit group BML, the bit group BLH, and the bit group BLL of the matrix B is an example of the partial significand data pair.

The significand of each of the elements is divided into six, and thus the multiplication result of the matrix multiplication of one element can be obtained by performing the multiplication of 9 bits 36 times in the significand of the double-precision data. Therefore, the multiplication result DBL of the matrix multiplication for one row (four elements) of the double precision can be obtained by performing the multiplication of 9 bits 144 times. However, in this case, in order to obtain two multiplication results DBL of the matrix multiplication for two rows, 288 9-bit multipliers are required, and the multiplication execution circuit 141 of FIG. 2 including 256 9-bit multipliers cannot perform the multiplication.

Therefore, the correction value CV may be used instead of the multiplication of the bit groups A_LH and BLH, the multiplication of the bit groups A_LH and BLL, the multiplication of the bit groups LL and BLH, and the multiplication of the bit groups A_LL and BLL among the 36 multiplications of each of the elements. With this, the matrix multiplication for one row of the matrix A can be performed by the 16 multiply-add circuits PS1.

Therefore, by using the multiplication execution circuit 141 of FIG. 2, two multiplication results DBL, which are the results of the matrix multiplication for two rows of the matrix A of 2 rows×4 columns and the matrix B of 4 rows×1 column of double-precision data, can be obtained. Here, the 32 multiplication results of the partial significand pairs of the respective elements may be added by the adder a after digit alignment using the shifters SFT in the multiply-add circuits PS1.

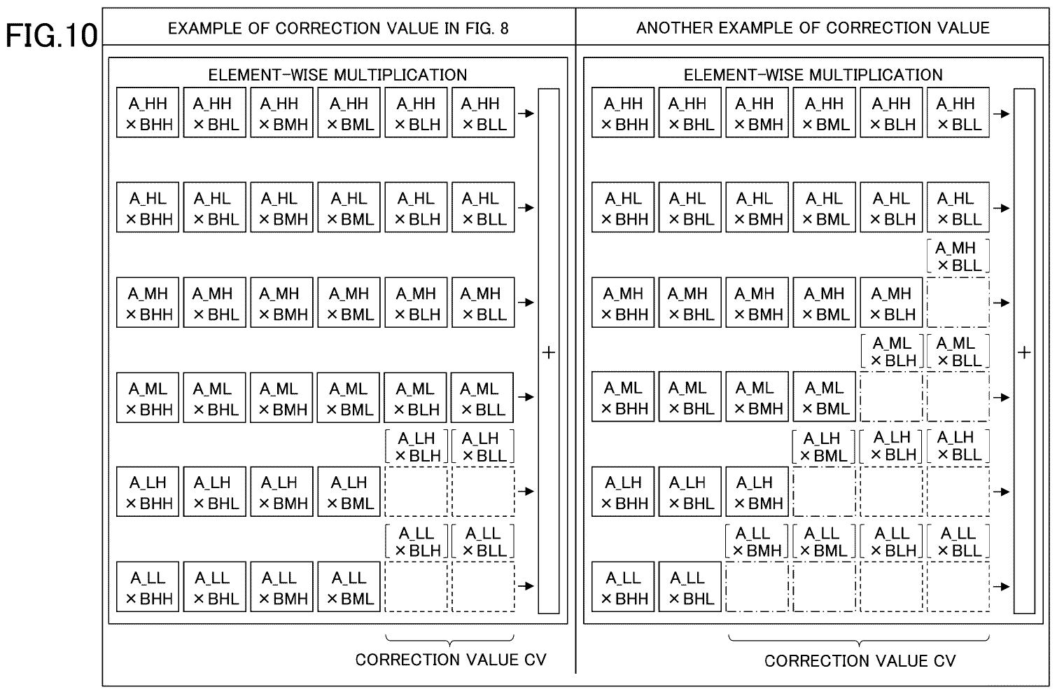

FIG. 10 is a diagram illustrating an example of replacement with the correction value when matrix multiplication of double-precision data is performed. In the matrix multiplication of the double-precision data illustrated in FIG. 8, as illustrated by the dashed line frame in the left frame of FIG. 10, the correction value CV may be given instead of performing the multiplication of the bit groups A_LH and BLH, the multiplication of the bit groups A_LH and BLL, the multiplication of the bit groups A_LL and BLH, and the multiplication of the bit groups A_LL and BLL for each of the elements. In this case, the correction value CV may be generated based on one or more of the pair of bit groups A_LH and BLH, the pair of bit groups A_LH and BLL, the pair of bit groups A_LL and BLH, and the pair of bit groups A_LL and BLL, or may be set to a fixed value (for example, “0”).

Additionally, as another example of the correction value, when the accuracy of matrix multiplication can be satisfied, as illustrated by a dashed-dotted line frame in the right frame of FIG. 10, the correction value CV may be given instead of performing the multiplication of the bit groups A_MH and BLL, the multiplication of the bit groups A_ML and BLH, the multiplication of bit groups A_ML and BLL, the multiplication of the bit groups A_LH and BML, the multiplication of bit groups A_LH and BLH, the multiplication of the bit groups A_LH and BLL, the multiplication of the bit groups A_LL and BMH, the multiplication of the bit groups A_LL and BML, the multiplication of the bit groups A_LL and BLH, and the multiplication of the bit groups A_LL and BLL for each of the elements.

The correction value CV may be generated based on one or more of the pair of bit groups A_MH and BLL, the pair of bit groups A_ML and BLH, the pair of bit groups A_ML and BLL, the pair of bit groups A_LH and BML, the pair of bit groups A_LH and BLH, the pair of bit groups A_LH and BLL, the pair of bit groups A_LL and BMH, the pair of bit groups A_LL and BML, the pair of bit groups A_LL and BLH, and the pair of bit groups A_LL and BLL, or may be set to a fixed value (for example, “0”).

This can reduce the number of the multipliers to be operated in comparison with the example illustrated in FIG. 8, and reduce the power consumption of the multiplication execution circuit 141 and the arithmetic device 100. Here, the number of the multipliers whose operations are to be stopped may be 31 or less.

As described above, in the first embodiment, the arithmetic device 100 can perform the matrix multiplication of the significands of the floating-point number data of multiple levels of precision by the common multiplication execution circuit 141. For example, each of the multiplication execution circuits 141 can perform the matrix multiplication of the significands of the half-precision, the pseudo single-precision, single-precision, and double-precision floating-point number data.

In the significands of the single-precision and double-precision floating-point number data, the correction value CV may be used instead of the data pair of the low-order bit groups that is not assigned to the multiplier among the multiple bit groups divided in accordance with the number of bits of the multiplier. With this, the matrix multiplication of the significands of the single-precision or double-precision floating-point number data can be performed by using the multiplication execution circuit 141 configured to perform the matrix multiplication of the significands of the half-precision or pseudo-single-precision floating-point number data.

The correction value generation circuit CVGEN provided in each of the multiply-add circuits PS1 generates the correction value CV based on the low-order partial significand data pair that is not assigned to the multiplier, thereby suppressing a decrease in the accuracy of the matrix multiplication result even when the multiplication of the low-order partial significand data pair is not performed.

Additionally, the correction value generation circuit CVGEN generates the correction value CV based on the control information supplied from the instruction decoder 130, and thus it can be determined whether to generate the correction value CV in accordance with the accuracy of the floating-point number data. In other words, the correction value CV can be generated only when the matrix multiplication of the single-precision or double-precision floating-point number data is performed.

Therefore, even when one multiplication execution circuit 141 is used for the matrix multiplication of the significands of the floating-point number data of multiple levels of precision, the correction value CV can be generated at the time of the matrix multiplication requiring the correction value CV, and generation of the correction value CV can be prevented at the time of the matrix multiplication not requiring the correction value CV. As a result, a malfunction of the arithmetic device 100 due to the correction value CV being erroneously generated can be prevented.

By stopping the operations of some of the multipliers in the multiply-add circuit PS1, the power consumption of the multiplication execution circuit 141 and the arithmetic device 100 can be reduced. The multiply-add circuit PS1 receives the position or the number of multipliers whose operations are to be stopped as the control information from the instruction decoder 130, thereby appropriately controlling the power consumption of the arithmetic device 100 in accordance with the precision of the floating-point number, the characteristics of the floating-point number to be used in the matrix multiplication, or the execution scale of matrix multiplication.

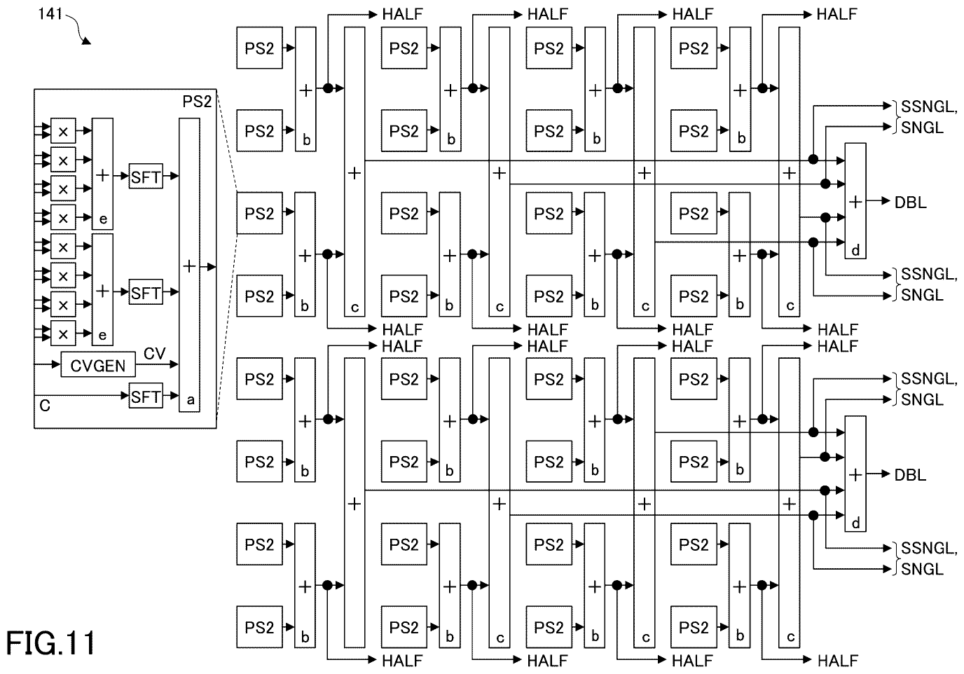

FIG. 11 is a block diagram illustrating an example of a configuration of an arithmetic device according to a second embodiment of the present disclosure. The same reference symbols are given to the elements substantially the same as those in FIG. 2, and detailed description thereof will be omitted. For example, a multiplication execution circuit 141 illustrated in FIG. 11 may be mounted on the arithmetic circuit 140 of the arithmetic device 100 in FIG. 1. The configuration of the multiplication execution circuit 141 illustrated in FIG. 11 is substantially the same as the configuration of the multiplication execution circuit 141 illustrated in FIG. 2 except that a multiply-add circuit PS2 is included instead of the multiply-add circuit PS1 in FIG. 2.

Each of the multiply-add circuits PS2 may include eight multipliers indicated by rectangles with x, two adders e each connected to outputs of four multipliers, shifters SFT each connected to an output of the adder e, a correction value generation circuit CVGEN configured generate a correction value CV, and an adder a. The adder a may add data from each of the shifter SFT, the correction value CV from the correction value generation circuit CVGEN, and a carry C. The adder e is an example of a second adder.

Each of the multipliers may multiply a 9-bit data pair indicating the significands of the block floating-point number data or the 9-bit partial significand data pair obtained by dividing each of the data pair of significands, and output a result of the multiplication to the adder e. An example of the matrix multiplication of the significands of the half-precision block floating-point number data having a significand of 9 bits is substantially the same as that in FIG. 4. Thus, in the following, an example of matrix multiplication of the significands of the pseudo single-precision, single-precision, and double-precision block floating-point number data will be described.

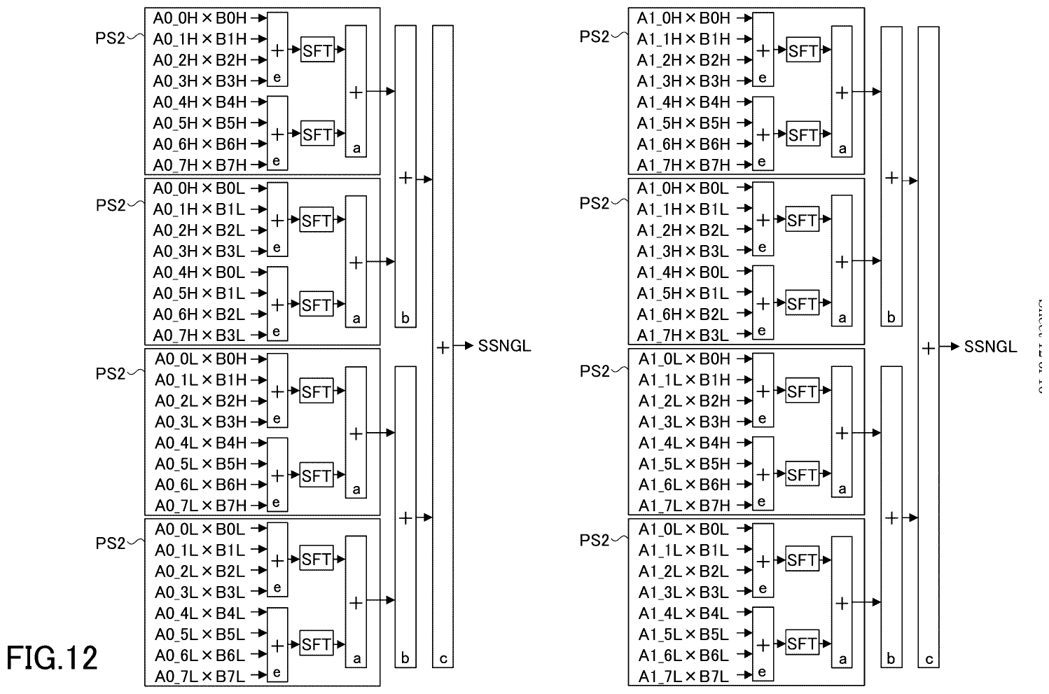

FIG. 12 is a diagram illustrating an example of the matrix multiplication of the significands of the pseudo single-precision data performed by the multiplication execution circuit 141 of FIG. 11. Detailed description of the elements and the operations substantially the same as those in FIG. 5 will be omitted. In the description of the bit groups H and L in FIG. 12, the description of the row number and the column number will be omitted. FIG. 12 illustrates an example of matrix multiplication in the first row (the left side of FIG. 12) and matrix multiplication in the second row (the right side of FIG. 12) in the matrix A of the pseudo single precision data illustrated in FIG. 5. In FIG. 12, the multiplier of each of the multiply-add circuits PS2 is represented by a multiplication expression.

The four multipliers connected to the inputs of each of the adders e of each of the multiply-add circuits PS2 illustrated in FIG. 12 may multiply, in the pseudo single-precision data, the partial significand data of the matrix A that have the same digit positions and the partial significand data of the matrix B that have the same digit positions. That is, each of the multiply-add circuits PS2 may multiply any one of the bit group A_H or the bit group A_L of the matrix A and any one of the bit group BH or the bit group BL of the matrix B for each set of the four multipliers connected to each of the adders e. Then, the matrix multiplication result SSNGL of the significands of the pseudo single precision block floating-point number data can be generated by the four multiply-add circuits PS2 (32 multipliers).

The digit positions of the multiplication results by the four multipliers connected to the each of the adders e can be aligned, and thus the shifter SFT of the multiply-add circuit PS2 can be connected to the output of the adder e, instead of being connected to each of the outputs of the eight multipliers. As a result, the number of the shifters SFT included in each of the multiply-add circuits PS2 can be reduced to one fourth of the number of the shifters SFT included in each of the multiply-add circuits PS1 in FIG. 3. Therefore, the circuit scale of the multiply-add circuit PS2 can be reduced in comparison with the circuit scale of the multiply-add circuit PS1, and the circuit scale of the multiplication execution circuit 141 can be reduced. The circuit scale of the multiplication execution circuit 141 can be reduced, thereby reducing the cost of the arithmetic device 100. Additionally, by reducing the number of the shifters SFT, the power consumption of the multiply-add circuit PS2 and the multiplication execution circuit 141 can be reduced.

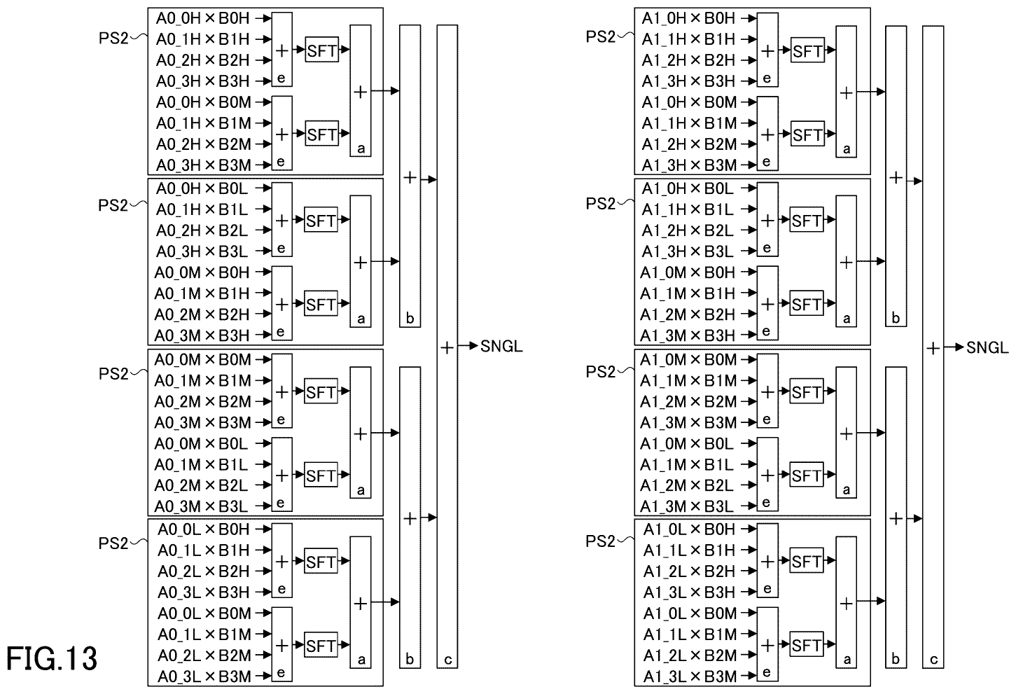

FIG. 13 is a diagram illustrating an example of matrix multiplication of the significands of the single-precision data performed by the multiplication execution circuit 141 in FIG. 11. Detailed description of substantially the same elements and the same operations as those in FIG. 6 will be omitted. In the description of the bit groups H, M, and L in FIG. 13, the description of the row number and the column number will be omitted. FIG. 13 illustrates an example of matrix multiplication in the first row (the left side of FIG. 13) and matrix multiplication in the second row (the right side of FIG. 13) in the matrix A of the pseudo single-precision data illustrated in FIG. 6. In FIG. 13, the multiplier of each of the multiply-add circuits PS2 is also represented by a multiplication expression.

In FIG. 13, the four multipliers connected to the inputs of each of the adders e of each of the multiply-add circuits PS2 may multiply, in the single-precision matrix, the partial significand data of the matrix A that have the same digit positions and the partial significand data of the matrix B that have the same digit positions.

That is, each of the multiply-add circuits PS2 may multiply any one of the bit group A H, the bit group A_M, or the bit group A_L of the matrix A and any one of the bit group BH, the bit group BM, or the bit group BL of the matrix B for each set of the four multipliers connected to each of the adders e (however, excluding the multiplication of the bit groups A_L and BL). The multiplication of the bit group A_L of the matrix A and the bit group BL of the matrix B is not performed, thereby generating the matrix multiplication result SNGL of the significands of the single-precision block floating-point number data by the four multiply-add circuits PS2 (32 multipliers).

As in the matrix multiplication of the pseudo single-precision data of FIG. 12, the digit positions of the multiplication results by the four multipliers connected to each of the adders e can be aligned, and thus the number of the shifters SFT included in each of the multiply-add circuits PS2 can be reduced to one fourth of the number of the shifters SFT included in each of the multiply-add circuits PS1 of FIG. 3.

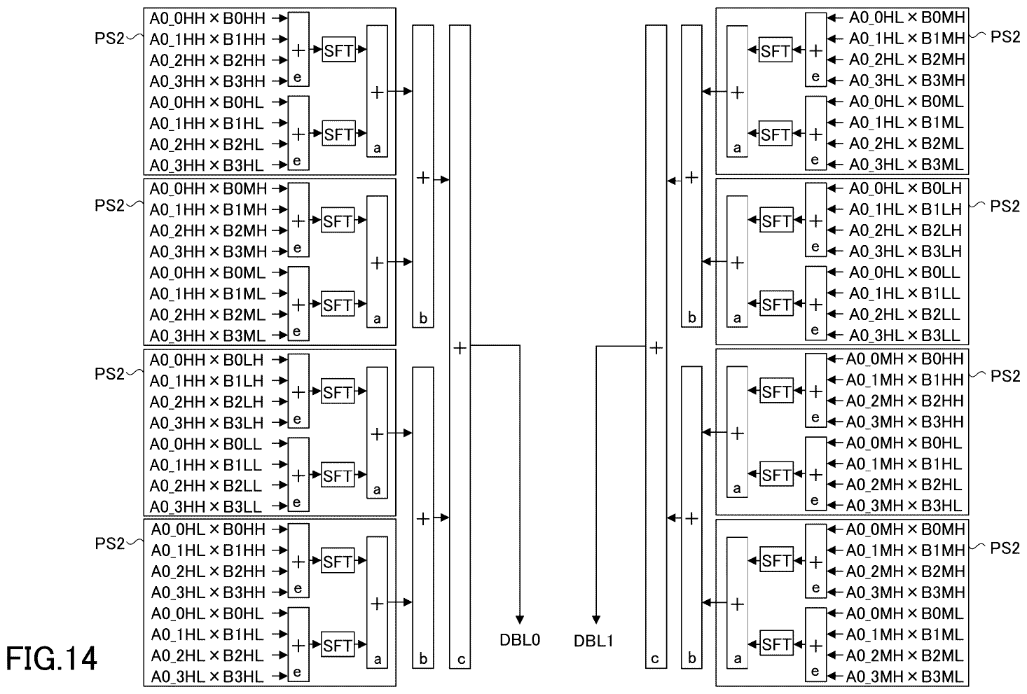

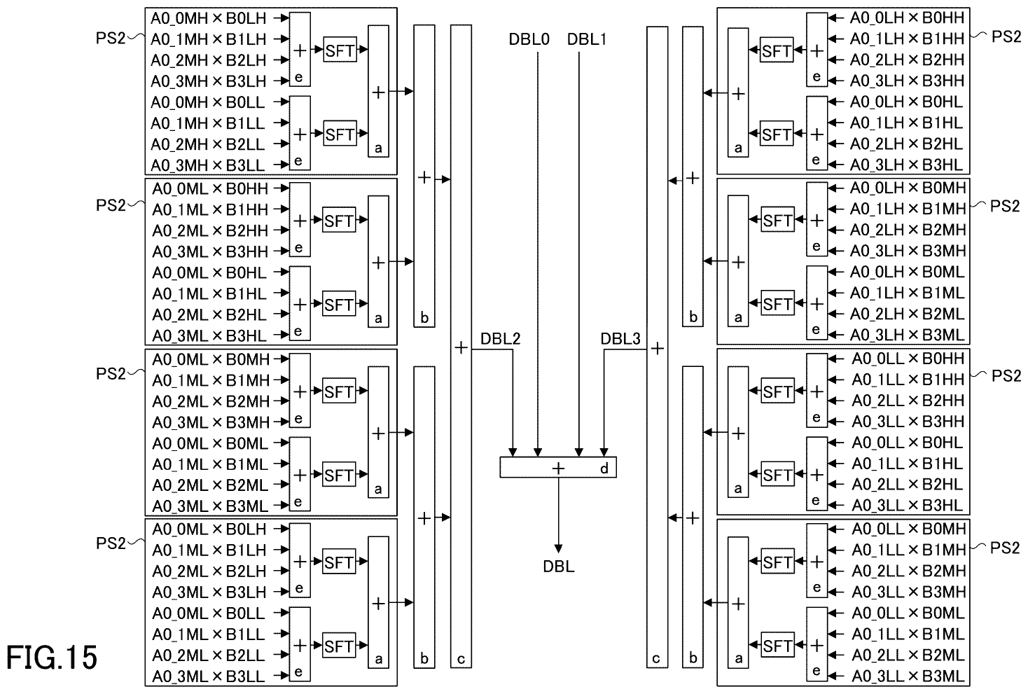

FIGS. 14 and 15 are diagrams illustrating an example of matrix multiplication of significands of double-precision data performed by the multiplication execution circuit in FIG. 11. Detailed description of substantially the same elements and the same operations as those in FIGS. 8 and 9 will be omitted. In the description of the bit groups HH, HL, MH, ML, LH, and LL in FIGS. 14 and 15, the description of the row number and the column number will be omitted. FIGS. 14 and 15 illustrates an example of matrix multiplication in the first row of the matrix A of the double-precision data illustrated in FIG. 8.

In FIGS. 14 and 15, the four multipliers connected to the inputs of each of the adders e of each of the multiply-add circuits PS2 may multiply, in the double-precision data, the partial significand data of the matrix A that have the same digit positions and the partial significand data of the matrix B that have the same digit positions.

That is, each of the multiply-add circuits PS2 may multiply any one of the bit group A_HH, the bit group A_HL, the bit group A MH, the bit group A_ML, the bit group A_LH, or the bit group A_LL of the matrix A and any one of the bit group BHH, the bit group BHL, the bit group BMH, the bit group BML, the bit group BLH, or the bit group BLL of the matrix B for each set of the four multipliers connected to each of the adders e (however excluding the multiplication of the bit groups A_LH and BLH, the bit groups A_LH and BLL, the bit groups A_LL and BLH, and the bit groups A_LL and BLL). The multiplication of the bit groups A_LH and BLH, the bit groups A_LH and BLL, the bit groups A_LL and BLH, and the bit groups A_LL and BLL is not performed, thereby generating the matrix multiplication result DBL of the significands of the double-precision block floating-point number data by 16 multiply-add circuits PS2 (128 multipliers).

As in the matrix multiplication of the significands of the pseudo-single-precision data in FIG. 12 and the matrix multiplication of the significands of the single-precision data in FIG. 13, the digit positions of the multiplication results of the four multipliers can be aligned, and thus the number of the shifters SFT included in each of the multiply-add circuits PS2 can be reduced to one fourth of the number of the shifters SFT included in each of the multiply-add circuits PS1 in FIG. 3.

Here, the four adders c in FIGS. 14 and 15 may output partial sums DBL0, DBL1, DBL2, and DBL3 of the multiplication results of 32 sets of the partial significands of the matrix A and the matrix B to the adder d in FIG. 15. The adder d (FIG. 15) may add the partial sums DBL0, DBL1, DBL2, and DBL3 and output the multiplication result DBL of the significands of the double-precision block floating-point number data.

As described above, in the second embodiment, substantially the same effects as those of the first embodiment can also be obtained. For example, the arithmetic device 100 can perform matrix multiplication of block floating-point number data of multiple levels of precision by the common multiplication execution circuit 141. For example, each of the multiplication execution circuits 141 can perform the matrix multiplication of the half-precision, pseudo single-precision, single-precision, and double-precision block floating-point number data.

By using the correction value CV instead of the bit pair of the low-order bit groups that is not assigned to the multiplier of the multiply-add circuit PS2, a decrease in the accuracy of the matrix multiplication result can be suppressed even when the multiplication of the low-order partial significand data pair is not performed. Additionally, even when one multiplication execution circuit 141 is used for matrix multiplication of significands of block floating-point number data of multiple levels of precision, generation of the correction value CV can be prevented by the correction value generation circuit CVGEN at the time of matrix multiplication in which the correction value CV is unnecessary, and a malfunction of the arithmetic device 100 can be prevented.

By stopping the operations of some of the multipliers in the multiply-add circuit PS2, the power consumption of the multiplication execution circuit 141 and the arithmetic device 100 can be reduced.

Further, in the second embodiment, by connecting the shifter SFT to the output of the adder e configured to add the multiplication results output by the multiple multipliers, the number of the shifters SFT included in each of the multiply-add circuits PS2 can be reduced in comparison with the case where the shifter SFT is connected to the output of each of the multipliers. As a result, the circuit scale of the multiply-add circuit PS2 can be reduced in comparison with the circuit scale of the multiply-add circuit PS1, and the circuit scale of the multiplication execution circuit 141 can be reduced. Additionally, by reducing the number of the shifters SFT, the power consumption of the multiply-add circuit PS2 and the multiplication execution circuit 141 can be reduced.

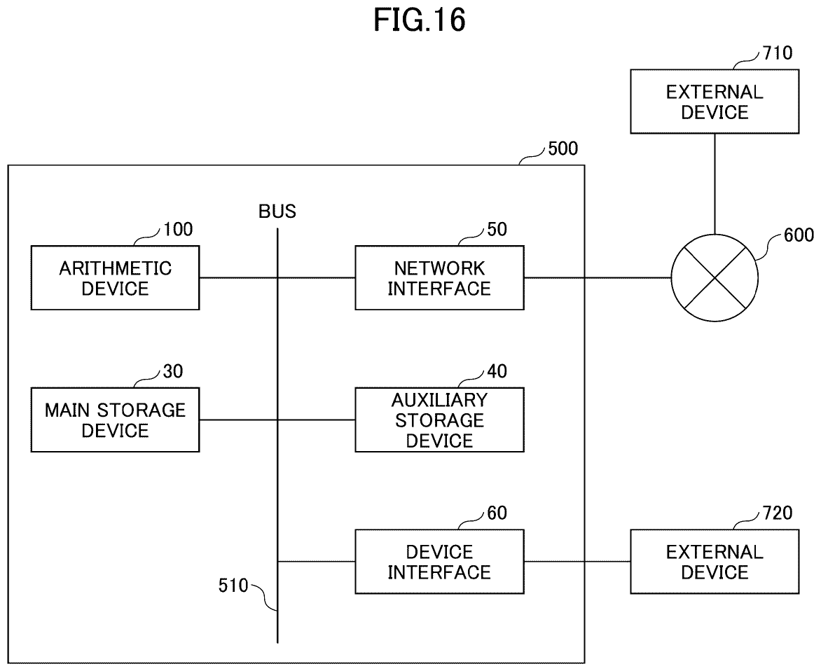

FIG. 16 is a block diagram illustrating an example of a hardware configuration of a computer in which the arithmetic device 100 illustrated in FIG. 1 is mounted. In FIG. 16, the computer may be implemented, as an example, as a computer 500 including the arithmetic device 100, a main storage device 30 (memory), an auxiliary storage device 40 (memory), a network interface 50, and a device interface 60, which are connected via a bus 510. For example, the main storage device 30 may be the external memory 200 illustrated in FIG. 1.

The computer 500 of FIG. 16 includes one of each component, but may include multiple units of the same components. Additionally, although one computer 500 is illustrated in FIG. 16, the software may be installed in multiple computers, and the multiple computers may execute the same or different partial processes of the software. In this case, the computers may be in a distributed computing form in which the computers communicate with each other via the network interface 50 or the like to perform the processing. That is, a system in which one or more computers 500 execute instructions stored in one or more storage devices to implement the functions may be configured. Additionally, information transmitted from a terminal may be processed by one or more computers 500 provided on the cloud, and a processing result may be transmitted to the terminal.

Various operations may be performed by parallel processing using one or more arithmetic devices 100 mounted on the computer 500 or using multiple computers 500 connected via a network. Additionally, various operations may be distributed to multiple operation cores in the arithmetic device 100 and performed by parallel processing. Additionally, some or all of the processes, means, and the like of the present disclosure may be implemented by at least one of a processor or a storage device provided on a cloud that can communicate with the computer 500 via a network. As described above, each of the devices in the above-described embodiments may be in a form of parallel computing by one or more computers.

The arithmetic device 100 may be an electronic circuit (a processing circuit, processing circuitry, a CPU, a GPU, an FPGA, an ASIC, or the like) that performs at least one of control or operations of a computer. Additionally, the arithmetic device 100 may be any of a general-purpose processor, a dedicated processing circuit designed to execute a specific operation, or a semiconductor device including both the general-purpose processor and the dedicated processing circuit. Additionally, the arithmetic device 100 may include an optical circuit or may include an arithmetic function based on quantum computing.

The arithmetic device 100 may perform arithmetic processing based on data or software input from each device or the like of the internal configuration of the computer 500, and may output an arithmetic result or a control signal to each device or the like. The arithmetic device 100 may control each component constituting the computer 500 by executing an operating system (OS), an application, or the like of the computer 500.

The main storage device 30 may store instructions executed by the arithmetic device 100, various data, and the like, and information stored in the main storage device 30 may be read by the arithmetic device 100. The auxiliary storage device 40 is a storage device other than the main storage device 30. Here, these storage devices indicate any electronic components capable of storing electronic information, and may be semiconductor memories. The semiconductor memory may be either a volatile memory or a nonvolatile memory. The storage device for storing various data and the like in the computer 500 may be realized by the main storage device 30 or the auxiliary storage device 40, or may be realized by a built-in memory built in the arithmetic device 100.

When the computer 500 is configured by at least one storage device (memory) and at least one arithmetic device 100 connected (coupled) to the at least one storage device, at least one arithmetic device 100 may be connected to one storage device. Additionally, at least one storage device may be connected to one arithmetic device 100. Additionally, a configuration in which at least one of the multiple arithmetic devices 100 is connected to at least one of the multiple storage devices may be included. Additionally, this configuration may be realized by the storage devices and the arithmetic devices 100 included in the multiple computers 500. Furthermore, a configuration in which the storage device is integrated with the arithmetic device 100 (for example, an L1 cache or a cache memory including an L2 cache) may be included.

The network interface 50 is an interface for connecting to the communication network 600 by wire or wirelessly. As the network interface 50, an appropriate interface, such as one conforming to an existing communication standard, may be used. The network interface 50 may exchange information with an external device 710 connected via the communication network 600. Here, the communication network 600 may be any one of a wide area network (WAN), a local area network (LAN), a personal area network (PAN), and the like, or a combination thereof as long as information is exchanged between the computer 500 and the external device 710. Examples of the WAN include the Internet and the like, and examples of the LAN include IEEE 802.11, Ethernet (registered trademark), and the like. Examples of the PAN include Bluetooth (registered trademark) and near field communication (NFC).

The device interface 60 is an interface, such as a USB, that is directly connected to an external device 720.

The external device 710 is a device connected to the computer 500 via a network. The external device 720 is a device directly connected to the computer 500.

The external device 710 or the external device 720 may be, for example, an input device. The input device is, for example, a device, such as a camera, a microphone, a motion capturing device, various sensors, a keyboard, a mouse, or a touch panel, and provides acquired information to the computer 500. Alternatively, the device may be a device including an input unit, a memory, and a processor, such as a personal computer, a tablet terminal, or a smartphone.

Additionally, the external device 710 or the external device 720 may be, for example, an output device. The output device may be, for example, a display device, such as a liquid crystal display (LCD) or an organic electro luminescence (EL) panel, or may be a speaker or the like that outputs sound or the like. Additionally, the device may be a device including an output unit, a memory, and a processor, such as a personal computer, a tablet terminal, or a smartphone.

Additionally, the external device 710 or the external device 720 may be a storage device (memory). For example, the external device 710 may be a network storage or the like, and the external device 720 may be a storage, such as an HDD.

Additionally, the external device 710 or the external device 720 may be a device having a function of a part of the components of the computer 500. That is, the computer 500 may transmit a part or all of the processing result to the external device 710 or the external device 720, or may receive a part or all of the processing result from the external device 710 or the external device 720.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e. g., “comprising”, “including”, or “having”) is used, the term is intended as an open- ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

Here, in the disclosed technique, aspects such as those described in the following appendix, are conceivable.

(Appendix 1) An arithmetic device includes:
a plurality of multiply-add circuits, each of which includes a plurality of multipliers and a first adder, each of the plurality of multipliers being configured to multiply a data pair of significands of floating-point number data, and the first adder being configured to add results of the multiplication by the plurality of multipliers and a correction value; and
an addition circuit configured to add operation results output from the plurality of multiply-add circuits and output a result of the addition as a matrix multiplication result of significand data of any of a plurality of types of floating-point number formats.

(Appendix 2) The arithmetic device as described in Appendix 1, wherein each of the plurality of multiply-add circuits includes a plurality of second adders connected to the plurality of multipliers, and shifters connected between the plurality of second adders and the first adder.

(Appendix 3) The arithmetic device as described in Appendix 1,
wherein, in a case where a number of bits of each of the data pair of the significands supplied to a multiply-add circuit among the plurality of multiply-add circuits is greater than a number of bits that is processed by each of the plurality of multipliers, the plurality of multipliers perform multiplication of high-order partial significand data pair among a plurality of partial significand data pairs obtained by combining any of a plurality of partial significand data obtained by dividing each of the data pair of the significands, by being assigned to the plurality of multipliers, the high-order partial significand data pair being a combination of high-order bits of the data pair of the significands, and
wherein the correction value is input to the first adder instead of partial significand data pair that is not assigned to the plurality of multipliers.

(Appendix 4) The arithmetic device as described in Appendix 3, wherein the multiply-add circuit includes a correction value generation circuit configured to generate the correction value based on partial significand data pair that is not assigned to the plurality of multipliers among the plurality of partial significand data pairs.

(Appendix 5) The arithmetic device as described in Appendix 4, further including an instruction output circuit configured to output, to the multiply-add circuit, control information for identifying a type of matrix multiplication to be performed and the floating-point number formats together with the data pair of the significands of the floating-point number data,
wherein the correction value generation circuit determines whether to generate the correction value based on the control information.

(Appendix 6) The arithmetic device as described in Appendix 5, wherein the multiply-add circuit stops operations of some of the plurality of multipliers based on the control information.

(Appendix 7) The arithmetic device as described in any one of Appendixes 1 to 6,
wherein the addition circuit includes:
   a plurality of third adders, each of which is configured to add two operation results respectively output from two multiply-add circuits among the plurality of multiply-add circuits; and
   a plurality of fourth adders, each of which is configured to add two addition results respectively output from two third adders among the plurality of third adders,
   wherein in a case where a pair of data of significands of a first floating-point number format is supplied to the multiply-add circuit, each of the plurality of third adders outputs a matrix multiplication result of the data of the significands of the first floating-point number format, and
   wherein, in a case where a data pair of significands of a second floating-point number format is supplied to the multiply-add circuit, a fourth adder among the plurality of forth adders outputs a matrix multiplication result of the data of the significands of the second floating-point number format, a number of bits of each of the significands of the second floating-point number format being greater than a number of bits of each of the significands of the first floating-point number format.

(Appendix 8) The arithmetic device as described in Appendix 7,
wherein each of the plurality of multipliers is a 9-bit multiplier,
wherein the first floating-point number format is a half-precision floating-point number format, and
wherein the second floating-point number format is a single-precision floating-point number format or a pseudo single-precision floating-point number format, a number of bits of a significand of the pseudo single-precision floating-point number format is greater than a number of bits of a significand of a half-precision floating-point number format and less than a number of bits of a significand of a single-precision floating-point number format.

(Appendix 9) The arithmetic device as described in Appendix 8,
wherein the addition circuit further includes a plurality of fifth adders, each of which is configured to add addition results respectively output from four fourth adders among the plurality of forth adders, and
wherein in a case where a pair of data of significands of a double-precision floating-point number format is supplied to the multiply-add circuit, a fifth adder among the plurality of fifth adders outputs a matrix multiplication result of the data of the significands of the double-precision floating-point number format.

(Appendix 10) The arithmetic device as described in any one of Appendixes 1 to 9, wherein a number of the plurality of multipliers is 2 to the power of i (i is a positive integer of 2 or greater).

What is claimed is:

1. An arithmetic device comprising:
a plurality of multiply-add circuits, each of which includes a plurality of multipliers and a first adder, each of the plurality of multipliers being configured to multiply a data pair of significands of floating-point number data, and the first adder being configured to add results of the multiplication by the plurality of multipliers and a correction value; and
an addition circuit configured to add operation results output from the plurality of multiply-add circuits and output a result of the addition as a matrix multiplication result of significand data of any of a plurality of types of floating-point number formats.

2. The arithmetic device as claimed in claim 1, wherein each of the plurality of multiply-add circuits includes a plurality of second adders connected to the plurality of multipliers, and shifters connected between the plurality of second adders and the first adder.

3. The arithmetic device as claimed in claim 1,
wherein, in a case where a number of bits of each of the data pair of the significands supplied to a multiply-add circuit among the plurality of multiply-add circuits is greater than a number of bits that is processed by each of the plurality of multipliers, the plurality of multipliers perform multiplication of high-order partial significand data pair among a plurality of partial significand data pairs obtained by combining any of a plurality of partial significand data obtained by dividing each of the data pair of the significands, by being assigned to the plurality of multipliers, the high-order partial significand data pair being a combination of high-order bits of the data pair of the significands, and
wherein the correction value is input to the first adder instead of partial significand data pair that is not assigned to the plurality of multipliers.

4. The arithmetic device as claimed in claim 3, wherein the multiply-add circuit includes a correction value generation circuit configured to generate the correction value based on partial significand data pair that is not assigned to the plurality of multipliers among the plurality of partial significand data pairs.

5. The arithmetic device as claimed in claim 4, further comprising an instruction output circuit configured to output, to the multiply-add circuit, control information for identifying a type of matrix multiplication to be performed and the floating-point number formats together with the data pair of the significands of the floating-point number data,
wherein the correction value generation circuit determines whether to generate the correction value based on the control information.

6. The arithmetic device as claimed in claim 5, wherein the multiply-add circuit stops operations of some of the plurality of multipliers based on the control information.

7. The arithmetic device as claimed in claim 1,
wherein the addition circuit includes:
a plurality of third adders, each of which is configured to add two operation results respectively output from two multiply-add circuits among the plurality of multiply-add circuits; and
a plurality of fourth adders, each of which is configured to add two addition results respectively output from two third adders among the plurality of third adders,
wherein in a case where a pair of data of significands of a first floating-point number format is supplied to each of the plurality of multiply-add circuits, each of the plurality of third adders outputs a matrix multiplication result of the data of the significands of the first floating-point number format, and
wherein, in a case where a data pair of significands of a second floating-point number format is supplied to each of the plurality of multiply-add circuits, a fourth adder among the plurality of forth adders outputs a matrix multiplication result of the data of the significands of the second floating-point number format, a number of bits of each of the significands of the second floating-point number format being greater than a number of bits of each of the significands of the first floating-point number format.

8. The arithmetic device as claimed in claim 7,
wherein each of the plurality of multipliers is a 9-bit multiplier,
wherein the first floating-point number format is a half-precision floating-point number format, and
wherein the second floating-point number format is a single-precision floating-point number format or a pseudo single-precision floating-point number format, a number of bits of a significand of the pseudo single-precision floating-point number format is greater than a number of bits of a significand of a half-precision floating-point number format and less than a number of bits of a significand of a single-precision floating-point number format.

9. The arithmetic device as claimed in claim 8,
wherein the addition circuit further includes a plurality of fifth adders, each of which is configured to add addition results respectively output from four fourth adders among the plurality of forth adders, and
wherein in a case where a pair of data of significands of a double-precision floating-point number format is supplied to each of the plurality of multiply-add circuits, a fifth adder among the plurality of fifth adders outputs a matrix multiplication result of the data of the significands of the double-precision floating-point number format.

10. The arithmetic device as claimed in claim 1, wherein a number of the plurality of multipliers is 2 to the power of i (i is a positive integer of 2 or greater).

11. An arithmetic method for execution by an arithmetic device including a plurality of multiply-add circuits and an addition circuit, each of the plurality of multiply-add circuits including a plurality of multipliers and a first adder, the arithmetic method comprising:
multiplying, by each of the plurality of multipliers, a data pair of significands of floating-point number data,
adding, by the first adder, results of the multiplication by the plurality of multipliers and a correction value; and
adding, by the addition circuit, operation results output from the plurality of multiply-add circuits and outputting a result of the addition as a matrix multiplication result of significand data of any of a plurality of types of floating-point number formats.

12. The arithmetic method as claimed in claim 11, wherein the adding by the first adder includes adding, by a plurality of second adders connected to the plurality of multipliers, the results of the multiplication, and shifting, by shifters connected between the plurality of second adders and the first adder, addition results output from the plurality of second adders.

13. The arithmetic method as claimed in claim 11,
wherein the multiplying by each of the plurality of multipliers includes performing, in a case where a number of bits of each of the data pair of the significands supplied to a multiply-add circuit among the plurality of multiply-add circuits is greater than a number of bits that is processed by each of the plurality of multipliers, multiplication of high-order partial significand data pair among a plurality of partial significand data pairs obtained by combining any of a plurality of partial significand data obtained by dividing each of the data pair of the significands, by being assigned to the plurality of multipliers, the high-order partial significand data pair being a combination of high-order bits of the data pair of the significands, and
wherein the correction value is input to the first adder instead of partial significand data pair that is not assigned to the plurality of multipliers.

14. The arithmetic method as claimed in claim 13, further comprising generating, by a correction value generation circuit included in the multiply-add circuit, the correction value based on partial significand data pair that is not assigned to the plurality of multipliers among the plurality of partial significand data pairs.

15. The arithmetic method as claimed in claim 14, further comprising outputting, by an instruction output circuit to the multiply-add circuit, control information for identifying a type of matrix multiplication to be performed and the floating-point number formats together with the data pair of the significands of the floating-point number data,
wherein the generating by the correction value generation circuit includes determining whether to generate the correction value based on the control information.

16. The arithmetic method as claimed in claim 15, further comprising stopping, by the multiply-add circuit, operations of some of the plurality of multipliers based on the control information.

17. The arithmetic method as claimed in claim 11,
wherein the adding by the addition circuit includes:
adding, by each of a plurality of third adders included in the addition circuit, two operation results respectively output from two multiply-add circuits among the plurality of multiply-add circuits; and
adding, by each of a plurality of fourth adders included in the addition circuit, two addition results respectively output from two third adders among the plurality of third adders,
wherein in a case where a pair of data of significands of a first floating-point number format is supplied to each of the plurality of multiply-add circuits, each of the plurality of third adders outputs a matrix multiplication result of the data of the significands of the first floating-point number format, and
wherein, in a case where a data pair of significands of a second floating-point number format is supplied to each of the plurality of multiply-add circuits, a fourth adder among the plurality of forth adders outputs a matrix multiplication result of the data of the significands of the second floating-point number format, a number of bits of each of the significands of the second floating-point number format being greater than a number of bits of each of the significands of the first floating-point number format.

18. The arithmetic method as claimed in claim 17,
wherein each of the plurality of multipliers is a 9-bit multiplier,
wherein the first floating-point number format is a half-precision floating-point number format, and
wherein the second floating-point number format is a single-precision floating-point number format or a pseudo single-precision floating-point number format, a number of bits of a significand of the pseudo single-precision floating-point number format is greater than a number of bits of a significand of a half-precision floating-point number format and less than a number of bits of a significand of a single-precision floating-point number format.

19. The arithmetic method as claimed in claim 18,
wherein the adding by the addition circuit includes adding, by each of a plurality of fifth adders included in the addition circuit, addition results respectively output from four fourth adders among the plurality of forth adders, and
wherein in a case where a pair of data of significands of a double-precision floating-point number format is supplied to each of the plurality of multiply-add circuits, a fifth adder among the plurality of fifth adders outputs a matrix multiplication result of the data of the significands of the double-precision floating-point number format.

20. The arithmetic method as claimed in claim 11, wherein a number of the plurality of multipliers is 2 to the power of i (i is a positive integer of 2 or greater).
